(19) United States
(12) Patent Application Publication
(10) Pub. No.: US 2008/0061138 A1
(43) Pub. Date: Mar. 13, 2008

(54) VALIDATION OF THE IDENTITY OF A REMOVABLE MEDIA VOLUME MOUNTED IN AN AUTOMATED DATA STORAGE LIBRARY

(75) Inventors: James Arthur Fisher, Tucson, AZ (US); Leonard George Jesionowski, Tucson, AZ (US)

Correspondence Address: LAW OFFICE OF DAN SHIFRIN, PC - IBM, 14081 WEST 59TH AVENUE, ARVADA, CO, 80004, US

(73) Assignee: INTERNATIONAL BUSINESS MACHINES CORPORATION, Armonk, NY (US)

(21) Appl. No.: 11/470,678

(22) Filed: Sep. 7, 2006

(51) Int. Cl. G06K 5/00

(52) U.S. Cl. 235/382

(57) ABSTRACT

In an automated data storage library, procedures are implemented to ensure that a correct volume is mounted before data is written to or read from the volume. After a host requests access to a specified volume, the volume is retrieved and mounted in a storage drive. The drive then verifies the volume serial number (VolSer) to ensure that it matches the VolSer of the requested volume. If the two VolSers are the same, the host is notified that the identity has been verified and access is allowed. If the two VolSers are different, an error recovery procedure may be initiated. The VolSer may be read by the drive through electronic means, such as a cartridge memory reader or an RFID tag reader, thereby avoiding potential problems which may result from physically reading or scanning an external label affixed to the volume.

### RELATED APPLICATION DATA

The present application is related to commonly-assigned and co-pending U.S. application Ser. No. 11/______ [IBM Docket #TUC920060129US1], entitled SELECTIVE ENCRYPTION OF DATA STORED ON REMOVABLE MEDIA IN AN AUTOMATED DATA STORAGE LIBRARY, which application is incorporated herein by reference in its entirety.

### FIELD OF THE INVENTION

This invention relates to automated data storage libraries, and more particularly, to validating the identification of a volume preventing a wrong volume from being accessed.

### BACKGROUND OF THE INVENTION

Automated data storage libraries are known for providing cost effective storage and retrieval of large quantities of data. The data in automated data storage libraries is stored on data storage media that are, in turn, stored on storage shelves or the like inside the library in a fashion that renders the media, and its resident data, accessible for physical retrieval. Such media is commonly termed “removable media.” Data storage media may comprise any type of media on which data may be stored and which may serve as removable media, including but not limited to magnetic media (such as magnetic tape or disks), optical media (such as optical tape or disks), electronic media (such as PROM, EEPROM, flash PROM, Compactflash™, Smartmedia™, Memory Stick™, etc.), or other suitable media. Typically, the data stored in automated data storage libraries is resident on data storage media that is contained within a cartridge and referred to as a data storage media cartridge. An example of a data storage media cartridge that is widely employed in automated data storage libraries for mass data storage is a magnetic tape cartridge.

In addition to data storage media, automated data storage libraries typically contain data storage drives that store data to, and/or retrieve data from, the data storage media. The transport of data storage media between data storage shelves and data storage drives is typically accomplished by one or more robot accessors (hereinafter termed “accessors”). Such accessors have grippers for physically retrieving the selected data storage media from the storage shelves within the automated data storage library and transport such media to the data storage drives by moving in the X and Y directions.

The full contents of a library are inventoried when the library is first installed and initialized. During the inventory, the physical location of each cartridge (such as the identity the storage shelf in which it resides) is determined and recorded by the library controller. Subsequently, when a host transmits a request to the controller to access to a particular volume (or cartridge), the controller can direct the accessor to the correct storage shelf.

During the operation of earlier generations of storage libraries, an external cartridge identification label representing the cartridge's volume serial number (VolSer), such as a bar code label, would be physically scanned each time the accessor moves it. Thus, the location of each cartridge would always be known. However, physical scanning is relatively time consuming and degrades the cartridge mount performance of the library.

On occasion, the door to a library frame will be opened to allow access to the interior for inspection, maintenance, the insertion or removal of cartridges or other reasons. Even if cartridges are not inserted or removed, it is possible that one or more cartridges may be accidentally moved within the library. In such an event, the original inventory will be rendered obsolete. However, a full inventory may be quite time consuming. Therefore, after a library frame door is closed again, it is common to perform an inventory on the contents of that frame and optionally, for additional assurance, on the contents of adjacent frames as well. Such a policy is based on the assumption that, as long as the library doors remain closed, the accessor will be trusted to return each cartridge to the correct shelf.

Unfortunately, a cartridge will occasionally be placed in the wrong location or a wrong label is affixed to a cartridge. The requesting host must then be able to detect that the wrong cartridge was mounted in a storage drive.

Moreover, it is particularly important that the correct cartridge be mounted when the data is encrypted. Otherwise, it might be possible for the host (and therefore a user) to improperly access or overwrite sensitive data.

Consequently, a need exists to ensure that the correct volume is mounted in a storage drive without adversely affecting the performance of the library.

### SUMMARY OF THE INVENTION

The present invention provides a method for validating the identification of a volume preventing a wrong volume from being accessed in an automated data storage library. A request from a host is received for a specified removable media volume to be mounted in a storage drive in the library, the specified volume being identified by a volume serial number (VolSer). The library controller directs a robotic accessor in the library to transport the specified volume to a storage drive and the specified volume is mounted in the drive. The drive reads the VolSer from the mounted volume and a comparison is made of the read VolSer with the VolSer of specified by the host. If the two are the same, the host is notified that the volume is correct and is accessible. Otherwise, an error recovery procedure may be initiated. The present invention also includes a computer program product having computer-readable code comprising instructions for executing the foregoing method.

The present invention also provides an automated data storage system in which the identification of a volume is validated before being made accessible. The system includes a plurality of storage shelves for storing data cartridges within a library housing unit, a library controller coupled to receive a request from a host device to access a specified data cartridge identified by a specified VolSer, a data storage drive, a robot accessor and a VolSer reader. Each data cartridge includes an identifying volume serial number (VolSer). The system further includes means for determining if the read VolSer is the same as the specified VolSer and means for notifying the host that the specified cartridge is accessible if the read VolSer is the same as the specified VolSer.

The present invention also includes a library controller for an automated data storage library. The controller includes a host interface, a library-accessor interface and a library-drive interface. A request from a host to access a specified data cartridge stored in a storage cell in the library is received through the host interface, the specified cartridge being identified by a requested volume serial number (VolSer). A request is transmitted to a robotic accessor through the library-accessor interface to transport the specified data cartridge to a storage drive. A VolSer of the specified data cartridge read by the storage drive is received through the library-drive interface. The library controller further includes means for comparing the VolSer read by the storage drive with the requested VolSer. The host interface is further operable to transmit a notification to the host that the specified volume is accessible if the read VolSer is the same as the requested VolSer.

The present invention further includes a data storage drive within an automated data storage library. The drive includes a loader mechanism into which a specified removable media cartridge is loaded, a VolSer reader operable to read the VolSer from the mounted cartridge and a library-drive interface. The library-drive interface is operable to transmit the VolSer to a library controller and receive instructions from the library controller to write data to and read data from the specified cartridge upon validation of the VolSer by the library controller.

### BRIEF DESCRIPTION OF THE DRAWINGS

FIG. 1 is an isometric view of an automated data storage library adaptable to implement an embodiment of the present invention, with the view specifically depicting a library having a left hand service bay, multiple storage frames and a right hand service bay;

FIG. 2 is an isometric view of an automated data storage library adaptable to implement an embodiment of the present invention, with the view specifically depicting an exemplary basic configuration of the internal components of a library;

FIG. 3 is a block diagram of an automated data storage library adaptable to implement an embodiment of the present invention, with the diagram specifically depicting a library that employs a distributed system of modules with a plurality of processor nodes;

FIG. 4 is a block diagram depicting an exemplary controller configuration;

FIG. 5 is an isometric view of the front and rear of a data storage drive adaptable to implement an embodiment of the present invention;

FIGS. 6A-6D are isometric views of data storage cartridges illustrating a variety of cartridge identifiers which may be used in the present invention;

FIG. 7 is a block diagram of an automated data storage library, including one embodiment of a library controller and a dedicated key server, in which the encryption system may be implemented; and

FIG. 8 is a flow chart of a method of the present invention.

### DETAILED DESCRIPTION OF THE INVENTION

This invention is described in preferred embodiments in the following description with reference to the Figures, in which like numerals represent the same or similar elements. While this invention is described in terms of the best mode for achieving this invention's objectives, it will be appreciated by those skilled in the art that it is intended to cover alternatives, modifications, and equivalents as may be included within the spirit and scope of the invention as defined by the appended claims.

The invention will be described as embodied in an automated magnetic tape library storage system for use in a data processing environment. Although the invention shown uses magnetic tape cartridges, one skilled in the art will recognize the invention equally applies to optical disk cartridges or other removable storage media and the use of either different types of cartridges or cartridges of the same type having different characteristics. Furthermore the description of an automated magnetic tape storage system is not meant to limit the invention to magnetic tape data processing applications as the invention herein can be applied to any media storage and cartridge handling systems in general.

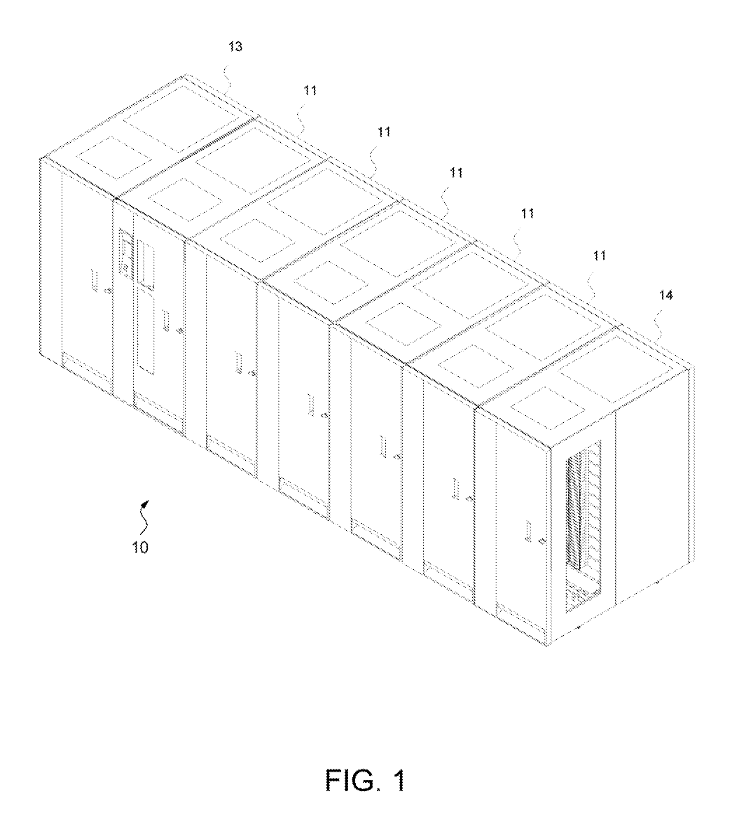

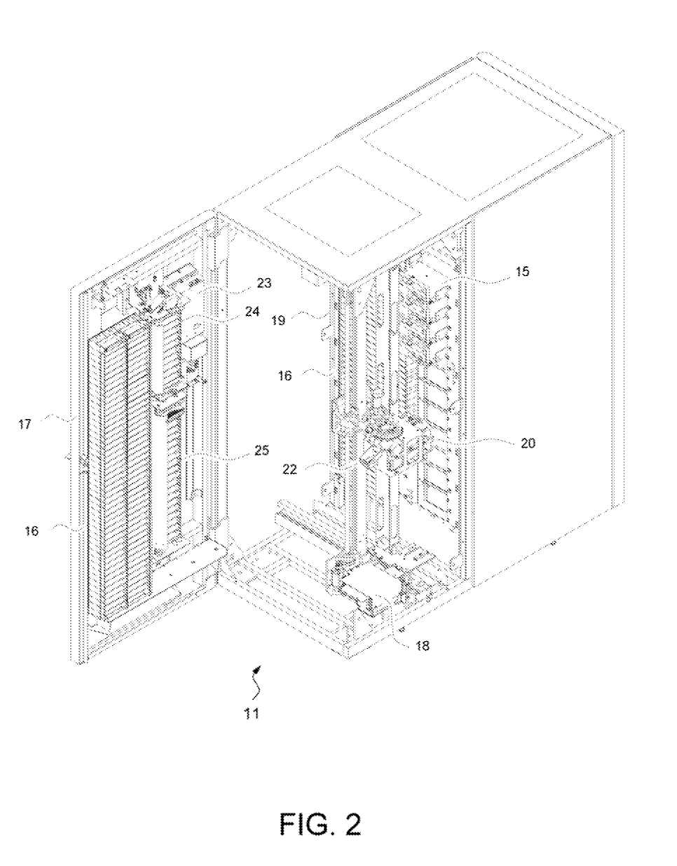

Turning now to the Figures, FIGS. 1 and 2 illustrate an automated data storage library 10 which stores and retrieves data storage cartridges containing data storage media (not shown) in storage shelves 16. It is noted that references to “data storage media” herein refer to data storage cartridges, and for purposes herein the two terms are used synonymously. An example of an automated data storage library which may implement the present invention, and has a configuration as depicted in FIGS. 1 and 2, is the IBM 3584 UltraScalable Tape Library. The library of FIG. 1 comprises a left hand service bay 13 one or more storage frames 11, and right hand service bay 14. As will be discussed, a frame may comprise an expansion component of the library. Frames may be added or removed to expand or reduce the size and/or functionality of the library. Frames may comprise additional storage shelves, drives, import/export stations, accessors, operator panels, etc.

FIG. 2 shows an example of a storage frame 11 which is the base frame of the library 10 and is contemplated to be the minimum configuration of the library. In this minimum configuration, there is only a single accessor (i.e., there are no redundant accessors) and there is no service bay. The library 10 is arranged for accessing data storage media in response to commands from at least one external host system (not shown), and comprises a plurality of storage shelves 16, one front wall 17 and rear wall 19 for storing data storage cartridges that contain data storage media; at least one data storage drive 15 for reading and/or writing data with respect to the data storage media; and a first accessor 18 for transporting the data storage media between the plurality of storage shelves 16 and the data storage drive(s) 15. The data storage drives 15 may be optical disk drives or magnetic tape drives, or other types of data storage drives as are used to read and/or write data with respect to the data storage media. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage media to be inserted into the library and/or removed from the library without disrupting library operation. The library 10 may comprise one or more storage frames 11 each having storage shelves 16 accessible by first accessor 18.

As described above, the storage frames 11 may be configured with different components depending upon the intended function. One configuration of storage frame 11 may comprise storage shelves 16, data storage drive(s) 15, and other optional components to store and retrieve data from the data storage cartridges. The first accessor 18 comprises a gripper assembly 20 for gripping one or more data storage media and may include a bar code scanner 22 or other reading system, such as a cartridge memory reader or similar system, mounted on the gripper 20, to “read” identifying information about the data storage media.

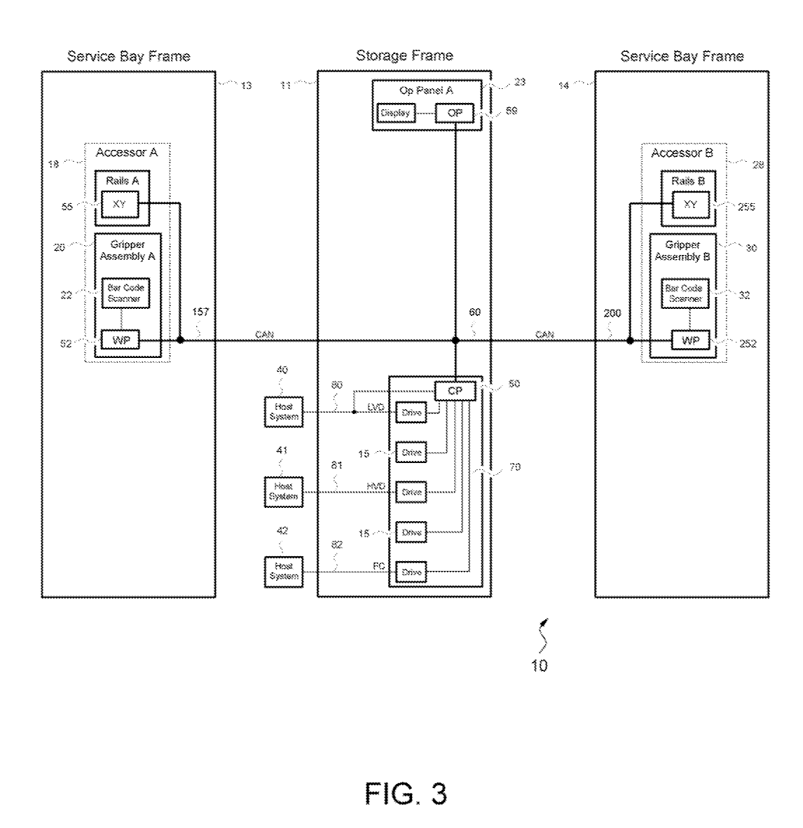

FIG. 3 illustrates an embodiment of an automated data storage library 10 of FIGS. 1 and 2, which employs a distributed system of modules with a plurality of processor nodes. An example of an automated data storage library which may implement the distributed system depicted in the block diagram of FIG. 3, and which implement the present invention, is the IBM 3584 UltraScalable Tape Library. For a fuller understanding of a distributed control system incorporated in an automated data storage library, refer to U.S. Pat. No. 6,356,803, which is entitled “Automated Data Storage Library Distributed Control System,” which is incorporated herein for reference.

While the automated data storage library 10 has been described as employing a distributed control system, the present invention may be implemented in automated data storage libraries regardless of control configuration, such as, but not limited to, an automated data storage library having one or more library controllers that are not distributed, as that term is defined in U.S. Pat. No. 6,356,803. The library of FIG. 3 comprises one or more storage frames 11, a left hand service bay 13 and a right hand service bay 14. The left hand service bay 13 is shown with a first accessor 18. As discussed above, the first accessor 18 comprises a gripper assembly 20 and may include a reading system 22 to “read” identifying information about the data storage media. The right hand service bay 14 is shown with a second accessor 28. The second accessor 28 comprises a gripper assembly 30 and may include a reading system 32 to “read” identifying information about the data storage media. In the event of a failure or other unavailability of the first accessor 18, or its gripper 20, etc. the second accessor 28 may perform some or all of the functions of the first accessor 18. The two accessors 18, 28 may share one or more mechanical paths or they may comprise completely independent mechanical paths. In one example, the accessors 18, 28 may have a common horizontal rail with independent vertical rails. The first accessor 18 and the second accessor 28 are described as first and second for descriptive purposes only and this description is not meant to limit either accessor to an association with either the left hand service bay 13, or the right hand service bay 14.

In the exemplary library, first accessor 18 and second accessor 28 move their grippers in at least two directions, called the horizontal “X” direction and vertical “Y” direction, to retrieve and grip or to deliver and release the data storage media at the storage shelves 16 and to load and unload the data storage media at the data storage drives 15.

The exemplary library 10 receives commands from one or more host systems 40, 41 or 42. The host systems, such as host servers, communicate with the library directly, e.g. on path 80, through one or more control ports (not shown), or through one or more data storage drives 15 on paths 81, 82, providing commands to access particular data storage media and move the media, for example, between the storage shelves 16 and the data storage drives 15. The commands are typically logical commands identifying the media and/or logical locations for accessing the media. The terms “commands” and “work requests” are used interchangeably herein to refer to such communications from the host system 40, 41 or 42 to the library 10 as are intended to result in accessing particular data storage media within the library 10.

The exemplary library is controlled by a distributed control system receiving the logical commands from hosts, determining the required actions, and converting the actions to physical movements of first accessor 18 and/or second accessor 28.

in the exemplary library, the distributed control system comprises a plurality of processor nodes; each having one or more processors. In one example of a distributed control system, a communication processor node 50 may be located in a storage frame 11. The communication processor node provides a communication link for receiving the host commands, either directly or through the drives 15, via at least one external interface, e.g., coupled to line 80.

The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18, and that is coupled to the communication processor node 50 via a network 60, 157. Each work processor node may respond to received commands that are broadcast to the work processor nodes from any communication processor node, and the work processor nodes may also direct the operation of the accessors, providing move commands. An XY processor node 55 may be provided and may be located at an XY system of first accessor 18. The XY processor node 55 is coupled to the network 60, 157, and is responsive to the move commands, operating the XY system to position the gripper 20.

Also, an operator panel processor node 59 may be provided at the optional operator panel 23 for providing an interface for communicating between the operator panel and the communication processor node 50, the work processor nodes 52, 252, and the XY processor nodes 55, 255.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as Ethernet, or a wireless network system, such as RF or infrared, may be employed in the library as is known to those of skill in the art. In addition, multiple independent networks may also be used to couple the various processor nodes.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the hosts and with the data storage drives. In the example of FIG. 3, host connections 80 and 81 are SCSI busses. Bus 82 comprises an example of a Fibre Channel bus which is a high speed serial data interface, allowing transmission over greater distances than the SCSI bus systems.

The data storage drives 15 may be in close proximity to the communication processor node 50, and may employ a short distance communication scheme, such as SCSI, or a serial connection, such as RS-422. The data storage drives 15 are thus individually coupled to the communication processor node 50 by means of lines 70. Alternatively, the data storage drives 15 may be coupled to the communication processor node 50 through one or more networks, such as a common bus network.

Additional storage frames 11 may be provided and each is coupled to the adjacent storage frame. Any of the storage frames 11 may comprise communication processor nodes 50, storage shelves 16, data storage drives 15, and networks 60.

Further, as described above, the automated data storage library 10 may comprise a plurality of accessors. A second accessor 28, for example, is shown in a right hand service bay 14 of FIG. 3. The second accessor 28 may comprise a gripper 30 for accessing the data storage media, and an XY system 255 for moving the second accessor 28. The second accessor 28 may run on the same horizontal mechanical path as first accessor 18, or on an adjacent path. The exemplary control system additionally comprises an extension network 200 forming a network coupled to network 60 of the storage frame(s) 11 and to the network 157 of left hand service bay 13.

In FIG. 3 and the accompanying description, the first and second accessors are associated with the left hand service bay 13 and the right hand service bay 14 respectively. This is for illustrative purposes and there may not be an actual association. In addition, network 157 may not be associated with the left hand service bay 13 and network 200 may not be associated with the right hand service bay 14. Depending on the design of the library, it may not be necessary to have a left hand service bay 13 and/or a right hand service bay 14.

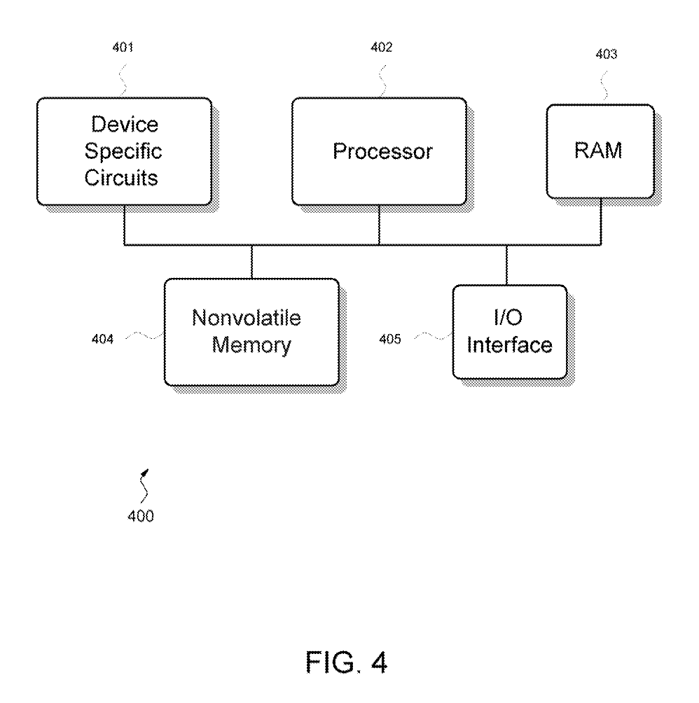

An automated data storage library 10 typically comprises one or more controllers to direct the operation of the automated data storage library. Host computers and data storage drives typically comprise similar controllers. A controller may take many different forms and may comprise, for example but not limited to, an embedded system, a distributed control system, a personal computer, or a workstation. Essentially, the term “controller” as used herein is intended in its broadest sense as a device that contains at least one processor, as such term is defined herein. FIG. 4 shows a typical controller 400 with a processor 402, RAM (Random Access Memory) 403, nonvolatile memory 404, device specific circuits 401, and I/O interface 405. Alternatively, the RAM 403 and/or nonvolatile memory 404 may be contained in the processor 402 as could the device specific circuits 401 and I/O interface 405. The processor 402 may comprise, for example, an off-the-shelf microprocessor, custom processor, FPGA (Field Programmable Gate Array), ASIC (Application Specific Integrated Circuit), discrete logic, or the like. The RAM (Random Access Memory) 403 is typically used to hold variable data, stack data, executable instructions, and the like. The nonvolatile memory 404 may comprise any type of nonvolatile memory such as, but not limited to, EEPROM (Electrically Erasable Programmable Read Only Memory), flash PROM (Programmable Read Only Memory), battery backup RAM, and hard disk drives. The nonvolatile memory 404 is typically used to hold the executable firmware and any nonvolatile data. The I/O interface 405 comprises a communication interface that allows the processor 402 to communicate with devices external to the controller. Examples may comprise, but are not limited to, serial interfaces such as RS-232, USB (Universal Serial Bus) or SCSI (Small Computer Systems Interface). The device specific circuits 401 provide additional hardware to enable the controller 400 to perform unique functions such as, but not limited to, motor control of a cartridge gripper. The device specific circuits 401 may comprise electronics that provide, by way of example but not limitation, Pulse Width Modulation (PWM) control, Analog to Digital Conversion (ADC), Digital to Analog Conversion (DAC), etc. In addition, all or part of the device specific circuits 401 may reside outside the controller 400.

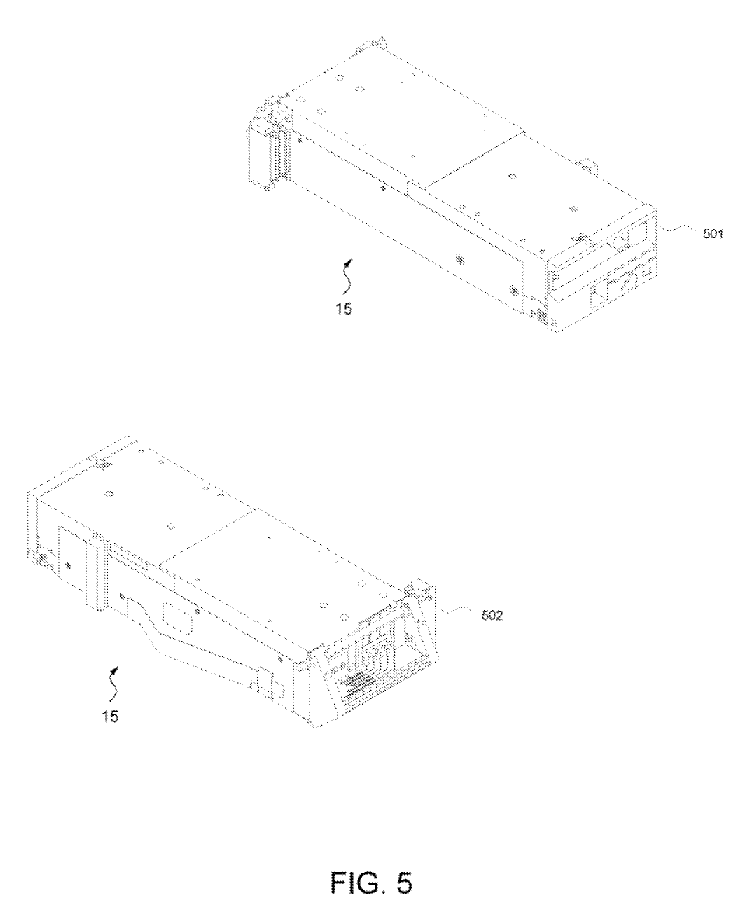

FIG. 5 illustrates an embodiment of the front 501 and rear 502 of a data storage drive 15. In the example of FIG. 5, the data storage drive 15 comprises a hot-swap drive canister. This is only an example and is not meant to limit the invention to hot-swap drive canisters. In fact, any configuration of data storage drive may be used whether or not it comprises a hot-swap canister.

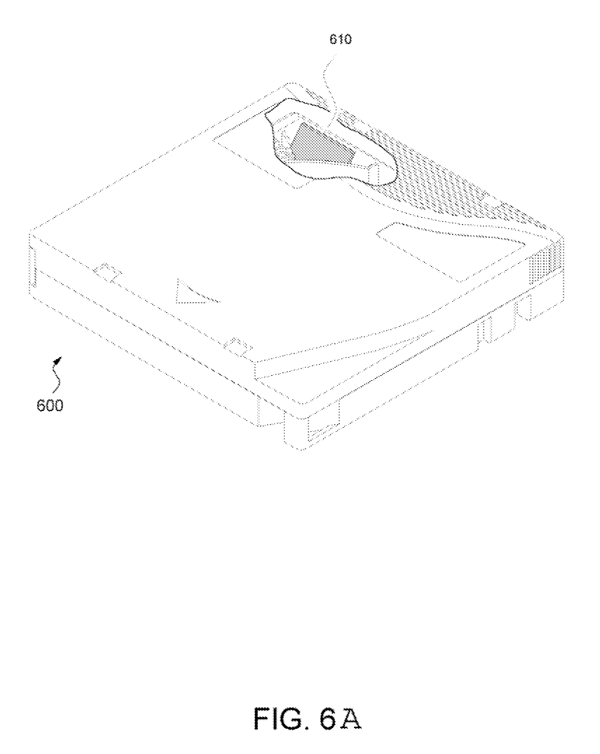

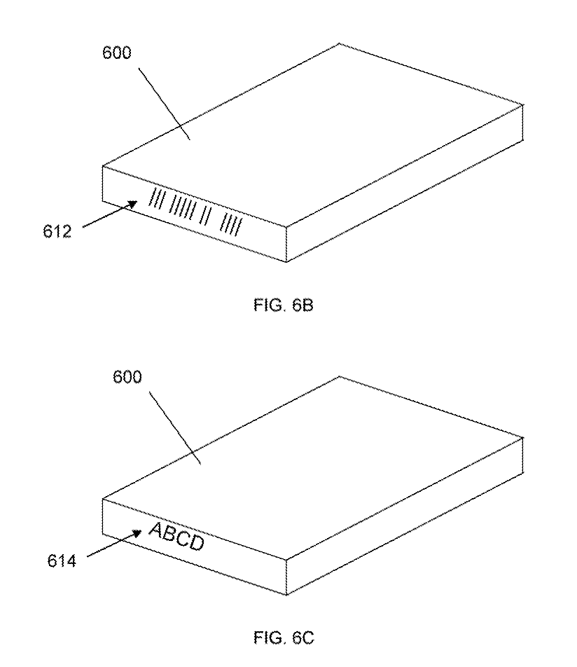

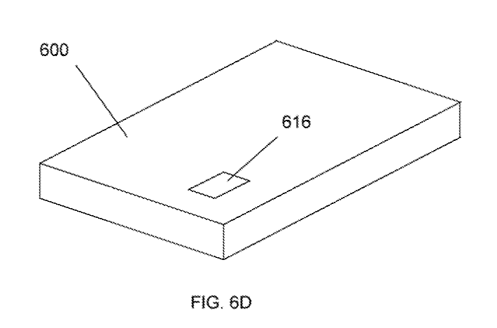

FIG. 6A illustrates an embodiment of a data storage cartridge 600 with a cartridge memory 610 shown in a cutaway portion of the Figure. Among other information, the cartridge memory 610 may store a value representative of volume serial number (VolSer) as an identification of the cartridge. The terms “cartridge” and “volume” are used herein interchangeably and refer both to the contents stored on the media within the cartridge and to the physical cartridge itself. The VolSer may also or alternatively be stored on an external machine-readable label 612 affixed to the cartridge 600 (FIG. 6B), an external human-readable label 614 affixed to the cartridge 600 (FIG. 6C) or a radio frequency identification (RFID) tag 616 affixed to the cartridge 600 (FIG. 6D) or any combination of these or other VolSer storage means.

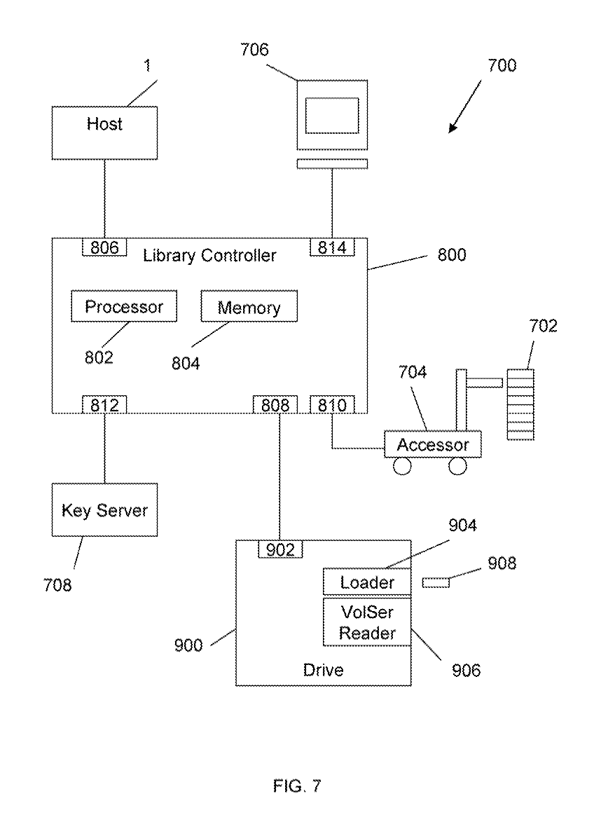

FIG. 7 is another block diagram of an automated data storage library 700 attached to one or more hosts 1. The library 700 includes a library controller 800, shelves 702, in which removable media cartridges may be stored, one or more data storage drives 900, and a robotic cartridge accessor 704 which, under the direction of the library controller 800, transports cartridges between the storage shelves 702 and the drive(s) 900. The library 700 may further include a user console 706 and a key server 708.

The library controller 800 includes a processor 802 operable to execute instructions stored in a memory 804. The controller 800 further includes a host interface 806, a drive interface 808, an accessor interface 810, a key server interface 812 and a console interface 814. The connection between the controller 800 and the drive 900 via the drive interface 808 may employ a library-drive interface (LDI) protocol as is known in the trade.

When the library 700 is configured to encrypt data, encryption keys are stored in the key server 708 in a secure manner. The key server 708 may be a dedicated PC or server (as illustrated in FIG. 7) and may be coupled to the controller 800 by any know means, such as, but not limited to, a direct link or a network, such as an Ethernet network employing TCP/IP. The key server 708 may also be integrated into the library controller or the host. A description of the components used in the encryption process, and the process itself is set forth in previously referenced, commonly-assigned and co-pending U.S. application Ser. No. 11/______ [IBM Docket #TUC920060129US1].

The storage drive 900 includes an interface 902 for interconnection with the library controller 800 through the library's drive interface 808. The drive 900 also includes a cartridge loader 904 to receive cartridges and a VolSer reader 906, The VolSer reader 906 detects and reads the VolSer of a cartridge 908 after the cartridge 908 has been loaded into the drive 900. The VolSer of the cartridge may be a value stored in a cartridge memory 610 (FIG. 6A) and the VolSer reader 906 is a cartridge memory reader. Alternatively, the VolSer of the cartridge may be a value stored in an RFID tag 616 (FIG. 6D) and the VolSer reader 906 is a an RFID reader. It will be appreciated that the VolSer may be recorded, stored or embedded in some other manner and the VolSer reader 906 may be any reader capable of reading the VolSer electronically rather than visually reading an external label.

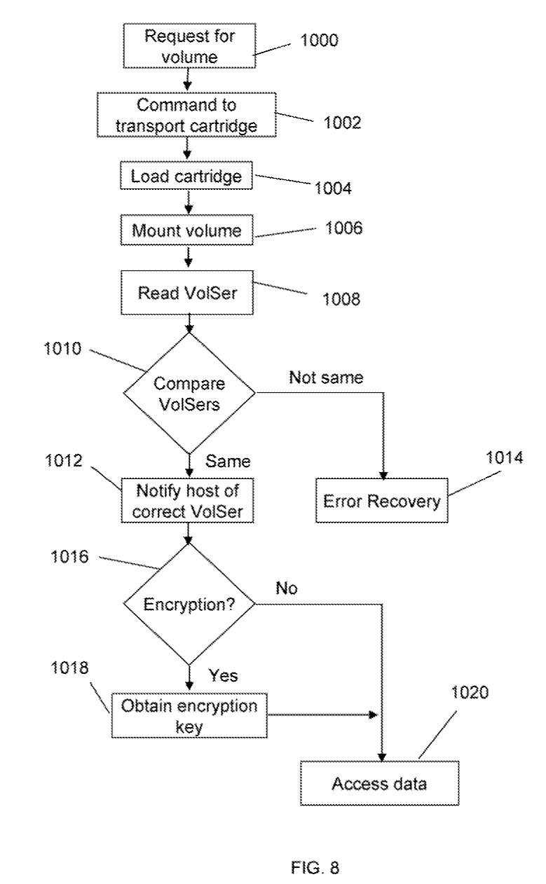

Referring also to the flow chart of FIG. 8, in operations the host 1 transmits a request to the library controller 800 to access a specified cartridge or volume 908, identified by its VolSer (step 1000). The controller 800 transmits a command to the accessor 704 to transport the specified cartridge 908 from a storage shelf 702 to the drive 900 (step 1002). After the cartridge 908 is loaded into the loader 904 (step 1004), the drive 900 mounts the cartridge (step 1006) and, using the VolSer reader 906, reads the VolSer of the cartridge 908 (step 1008). The read VolSer is then be compared with the VolSer of the specified volume (step 1010). The comparison may be performed by the drive 900 or by the library controller 800. If the read VolSer is the same as the requested VolSer, the library controller 800 notifies the host 1 that the volume that has been loaded and mounted is the requested volume and is ready to be accessed by writing data to or reading data from the volume (step 1012). If, on the other hands the read VolSer is not the same as the requested VolSer, the library controller 800 may initiate an error recovery procedure (step 1014), such as failing the mount back to the host. Thus, the host is permitted to only access the correct, requested volume and is prevented from accessing a wrong volume (that may, for example, have been stored in the wrong storage shelf or have had the wrong external identification label affixed to it).

If the library is configured to encrypt data and the VolSer of the specified volume 908 indicates that data has been or is to be encrypted (step 1016), the drive 900 may obtain the encryption key from the key server 708 (step 1018) as described in the previously identified reference and encrypt data being written to and decrypt data being read from the specified volume 908 in accordance with the encryption key and the data may then be accessed (step 1020).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CO-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for validating an identity of removable media in an automated storage library.

What is claimed is:

1. A method for validating an identity of removable media in an automated storage library, comprising:
receiving a request from a host for a specified removable media volume to be mounted in a storage drive in the library, the specified volume being identified by a volume serial number (VolSer);
directing a robotic accessor in the library to transport the specified volume to the storage drive;
mounting the specified volume in the storage drive;
reading the VolSer from the mounted volume;
comparing the read VolSer with the VolSer of identified by the host;
if the read VolSer and the VolSer of the volume identified by the host are the same, notifying the host that the volume is accessible; and
if the read VolSer with the VolSer of the volume identified by the host are not the same, initiating an error recovery procedure.

2. The method of claim 1, further comprising, if the read VolSer with the VolSer of the volume identified by the host are the same, obtaining an encryption key associated with the specified volume whereby data written to the volume is encrypted and data read from the volume is decrypted in accordance with the encryption key.

3. The method of claim 1, wherein the VolSer of the specified volume is read by the storage drive.

4. The method of claim 3, wherein the VolSer is read from a cartridge memory of the specified volume.

5. The method of claim 3, wherein the VolSer is read from media within a cartridge of the specified volume.

6. The method of claim 3, wherein the VolSer is read from an RFID affixed to the specified volume.

7. An automated data storage system, comprising:
a plurality of storage shelves for storing data cartridges within a library housing unit, a data storage cartridge including data storage medium and an identifying volume serial number (VolSer);
a library controller coupled to receive a request from a host device to access a specified data cartridge identified by a specified VolSer;
a data storage drive operable to mount the specified cartridge and read data to and/or write data therefrom under the direction of the library controller;
a robot accessor for transporting the specified cartridges between a storage shelves and the storage drive under the direction of the library controller,
a VolSer reader operable to read the VolSer from the mounted cartridge;
means for determining if the read VolSer is the same as the specified VolSer; and
means for notifying the host that the specified cartridge is accessible if the read VolSer is the same as the specified VolSer.

8. The system of claim 7, wherein the robot accessor includes the means for reading the VolSer.

9. The system of claim 7, wherein the storage drive includes the means for reading the VolSer.

10. The system of claim 9, wherein the VolSer is stored in a cartridge memory of the specified cartridge and the means for reading the VolSer comprises a cartridge memory reader.

11. The system of claim 9, wherein the VolSer is stored on the media within specified cartridge and the means for reading the VolSer comprises a media reader.

12. The system of claim 9, wherein the VolSer is stored in an REID affixed to the specified cartridge and the means for reading the VolSer comprises an RFID reader.

13. The system of claim 7, wherein the storage drive further comprises:
an interface through which the storage drive requests and obtains an encryption key; and
an encryption module for encrypting data written to and decrypting data read from the volume in accordance with the encryption key.

14. A library controller for an automated data storage library, comprising:
a host interface through which to receive a request from a host to access a specified data cartridge, identified by a requested volume serial number (VolSer), stored in a storage cell in the library;
a library-accessor interface through which to transmit a request to a robotic accessor to transport the specified data cartridge to a storage drive;
a library-drive interface through which to receive a VolSer of the specified data cartridge read by the storage drive;
means for comparing the VolSer read by the storage drive with the requested VolSer; and
the host interface further operable to transmit a notification to the host that the specified volume is accessible if the read VolSer is the same as the requested VolSer.

15. The library controller of claim 14,
the library-drive interface further operable to receive a request from the storage drive for an encryption key in response to the storage drive matching the specified data cartridge with a corresponding encryption policy;
an interface for obtaining the requested encryption key from a key server; and
the library-drive interface further operable to transmit the encryption key to the storage drive, whereupon the storage drive may encrypt data being written to, and decrypt data being read from, the specified data cartridge.

16. A data storage drive within an automated data storage library comprising:
a loader mechanism into which a specified removable media cartridge is loaded;
a VolSer reader operable to read the VolSer from the mounted cartridge; and
a library-drive interface operable to:
transmit the VolSer to a library controller; and
receive instructions from the library controller to write data to and read data from the specified cartridge upon validation of the VolSer by the library controller.

17. The storage drive of claim 16, wherein:
the library-drive interface is further operable to receive an encryption key from the library controller upon validation of the VolSer by the library controller; and
an encryption module to encrypt data being written to, and decrypt data being read from, the loaded data cartridge.

18. The storage drive of claim 16, wherein the VolSer reader comprises a cartridge memory reader.

19. The storage drive of claim 16, wherein the VolSer reader comprises a media reader.

20. The storage drive of claim 16, wherein the VolSer reader comprises an RFID reader.

21. A computer program product of a computer readable medium usable with a programmable computer, the computer program product having computer-readable code embodied therein for validating an identity of removable media in an automated storage library, the computer-readable code comprising instructions for:
receiving a request from a host for a specified removable media volume to be mounted in a storage drive in the library, the specified volume being identified by a volume serial number (VolSer);
directing a robotic accessor in the library to transport the specified volume to the storage drive;
mounting the specified volume in the storage drive;
reading the VolSer from the mounted volume;
comparing the read VolSer with the VolSer of identified by the host;
if the read VolSer and the VolSer of the volume identified by the host are the same, notifying the host that the volume is accessible; and
if the read VolSer with the VolSer of the volume identified by the host are not the same, initiating an error recovery procedure.

22. The computer program product of claim 21, further comprising instructions for, if the read VolSer with the VolSer of the volume identified by the host are the same, obtaining an encryption key associated with the specified volume whereby data written to the volume is encrypted and data read from the volume is decrypted in accordance with the encryption key.

23. The computer program product of claim 21, wherein the VolSer of the specified volume is read by the storage drive.

24. The computer program product of claim 23, wherein the VolSer is read from a cartridge memory of the specified volume.

25. The computer program product of claim 23, wherein the VolSer is read from media within a cartridge of the specified volume.

26. The computer program product of claim 23, wherein the VolSer is read from an RFID affixed to the specified volume.
